(19) United States
(12) Patent Application Publication
(10) Pub. No.: US 2010/0124942 A1
(43) Pub. Date: May 20, 2010

(54) COMBINATION ELECTRONIC CARD AND WIRELESS TRANSCEIVER WITH TOUCH CONTROL AND REMOTE CONTROL FUNCTIONS

(75) Inventors: Wen Sheng Liao, Taipei Hsien (TW); Jui Ming Chang, Taipei Hsien (TW)

Correspondence Address: RAYTAC CORP., P.O. BOX 108-00403, TAIPEI, TW

(73) Assignees: RAYTAC CORP., Taipei Hsien (TW); AVOV TECHNOLOGY PTE LTD., Techniques Centre (SG)

(21) Appl. No.: 12/274,367

(22) Filed: Nov. 20, 2008

(51) Int. Cl. H04B 1/38

(52) U.S. Cl. 455/558

(57) ABSTRACT

A combination electronic card and wireless transceiver includes a wireless transceiver connectable to a host, and an electronic card that has a wireless transmission interface for two-way communication with the wireless transceiver wirelessly, a touch panel for operation by a user with a finger to control the cursor on the display screen of the host wirelessly, a set of operation buttons for switching control of functional selections, and a recessed chamber for accommodating the wireless transceiver when not in use.

### BACKGROUND OF THE INVENTION

1. Field of the Invention

The present invention relates to an electronic card and more particularly, to a combination electronic card and wireless transceiver, which allows a user to control the cursor on a display screen of a host wirelessly through a touch panel on the electronic card.

2. Description of the Related Art

Following fast development of modern technology, electronic automation has been intensively employed to replace conventional human labor operation works. For example, different computers are intensively used in factories to control different mechanical machining processes or manufacturing processes. Computers are also intensively used in offices for data processing to build files, to store, back up, read, correct or print data, improving working efficiency and accuracy and avoiding errors or mistakes. Conventionally, when holding a meeting or making a report or presentation, or introducing a new product, a blackboard or whiteboard may be used to write or record things. Nowadays, many electronic presentation systems are created for enabling people to make a presentation conveniently by means of an image projector. When switching the page during a presentation, the lecturer can directly control a remote control to achieve the control. However, when wishing to move the cursor on the page, the lecturer must leave from the reading-desk or the place where the lecturer gives a lecture and approach to the host of the presentation system to control the movement of the cursor. It is inconvenient to operate the keyboard or cursor control device of the presentation system when making a presentation.

Therefore, it is necessary to provide a system that facilitates performance of a presentation.

### SUMMARY OF THE INVENTION

The present invention has been accomplished under the circumstances in view. It is therefore one object of the present invention to provide a combination electronic card and wireless transceiver, which provides a touch control function and a remote control function for controlling the cursor on the display screen of the host wirelessly.

To achieve this and other objects of the present invention, the combination electronic card and wireless transceiver is comprised of an electronic card and a wireless transceiver. The wireless transceiver has a connection interface for direct connection to a matching connection interface of a host. The electronic card comprises a wireless transmission interface for two-way communication with the wireless transceiver, a set of operation buttons for switching of functional selections, and a touch panel for controlling a cursor in a wireless manner on the display screen of the host to which the wireless transceiver is connected. The electronic card further has a recessed chamber for accommodating the wireless transceiver when not in use.

### BRIEF DESCRIPTION OF THE DRAWINGS

FIG. 1 is an oblique bottom elevation of a combination electronic card and wireless transceiver in accordance with the present invention.

FIG. 2 is perspective view of the combination electronic card and wireless transceiver in accordance with the present invention.

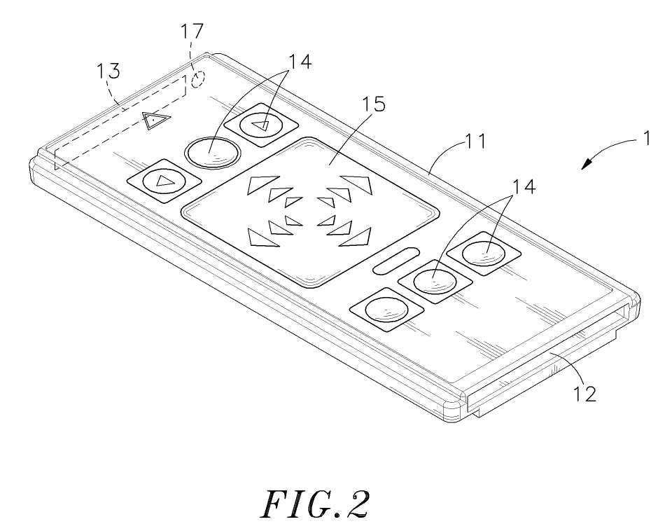

FIG. 3 illustrates the wireless transceiver removed from the recessed chamber of the electronic card according to the present invention.

FIG. 4 is a system block diagram of the present invention.

FIG. 5 shows an application example of the present invention.

FIG. 6 is a schematic drawing of the present invention, showing an operation status of the touch panel.

### DETAILED DESCRIPTION OF THE PREFERRED EMBODIMENT

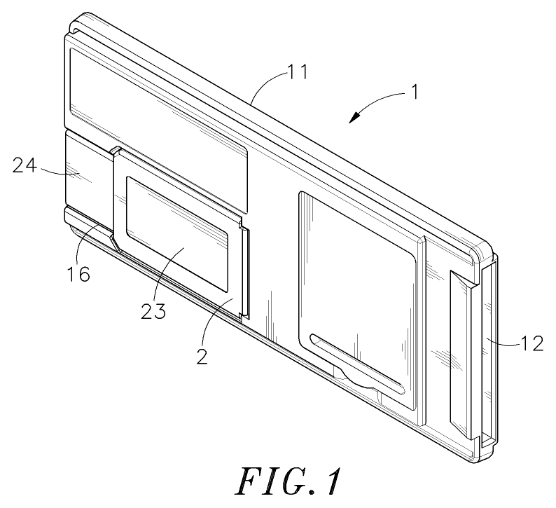

Referring to FIGS. 1˜4, a combination electronic card and wireless transceiver in accordance with the present invention is shown comprised of an electronic card 1 and a wireless transceiver 2.

The electronic card 1 comprises a housing 11 configured subject to the specification of a PCMCIA card, Express card or any of a variety of other expansion cards, a microprocessor 111 mounted inside the housing 11, a connection interface 12 provided at one end in the housing 11, a wireless transmission interface 13 provided at the other end in the housing 11, a set of operation buttons 14 and a touch panel 15 located on the top side of the housing 11, a recessed chamber 16 located on the bottom side of the housing 11, and a laser pointer 17 disposed adjacent to one side of the wireless transmission interface 13.

The wireless transceiver 2 comprises a microprocessor 21, a signal transmission interface 22, a display screen 23 and a connection interface 24.

The wireless transceiver 2 can be accommodated in the recessed chamber 16 of the electronic card 1 or removed from the electronic card 1. When inserted into the recessed chamber 16, the wireless transceiver 2 is firmly secured to the electronic card 1 by means of a frictional resistance force. After removal from the electronic card 1, the wireless transceiver 2 can be directly electrically connected to a host 3 with its connection interface 24 for enabling the host 3 to communicate with the electronic card 1 wirelessly. When the wireless transceiver 2 received a signal from the host 3, the microprocessor 21 controls the signal transmission interface 22 to start two-way wireless communication with the wires transmission interface 13 of the electronic card 1. At this time, the user can operate the operation buttons 14 to transmit signal to the host 3 (personal computer, notebook computer, PDA or the like) via the signal transmission interface 22 of the wireless transceiver 2 and the wireless transmission interface 13 of the electronic card 1. The user can also touch the touch panel 15 and move the finger on the touch panel 15, causing the touch panel 15 to produce a corresponding induction signal and to send the signal to the microprocessor 111 for processing so that the microprocessor 111 can send the signal to the signal transmission interface 22 of the wireless transceiver 2 via the wireless transmission interface 13. Upon receipt of the signal from the electronic card 1, the signal transmission interface 22 of the wireless transceiver 2 processes the signal and then sends the processed signal to the host 3 via the connection interface 24.

The aforesaid electronic card 1 can be a PCMCIA card, Express card or any of a variety of other expansion cards. The connection interface 12 can be a PCMCIA card connector, Express card connector or a card connector for any of a variety of other expansion cards. The wireless transmission interface 13 of the electronic card 1 and the signal transmission interface 22 of the wireless transceiver 2 can be an infrared transmission interface, radio transmission interface, or configured subject to any of a variety of other wireless transmission techniques. Further, the connection interface 24 of the wireless transceiver 2 and a connection interface 31 of the host 3 can be configured subject to USB (Universal Serial Bus), IEEE 1394 (Institute of Electrical Electronics Engineers) or RS485.

The wireless transceiver 2 is a wireless transmitter and receiver capable of transmitting and receiving an infrared signal, radio signal or predetermined wireless signal. Besides, the wireless transceiver 2 can be built-in the host 3. Alternatively, the wireless transceiver 2 can electrically connect to the host 3 through the connection interface 24.

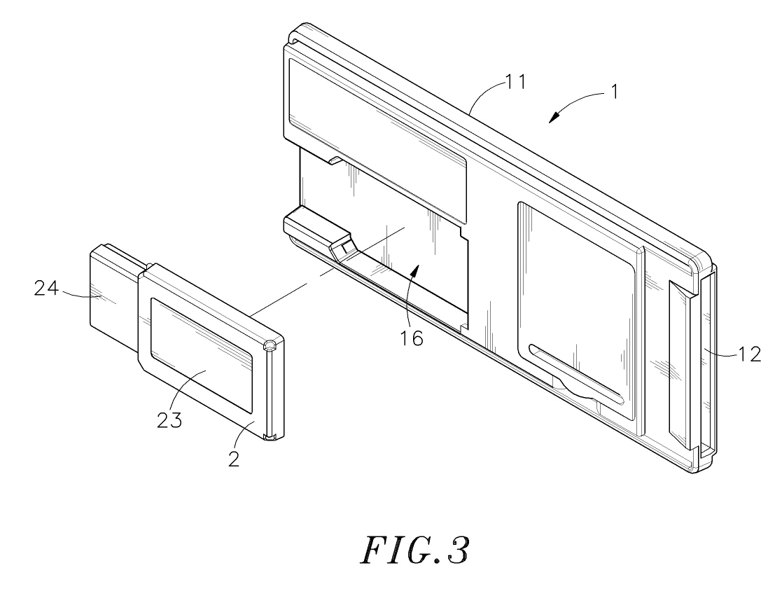

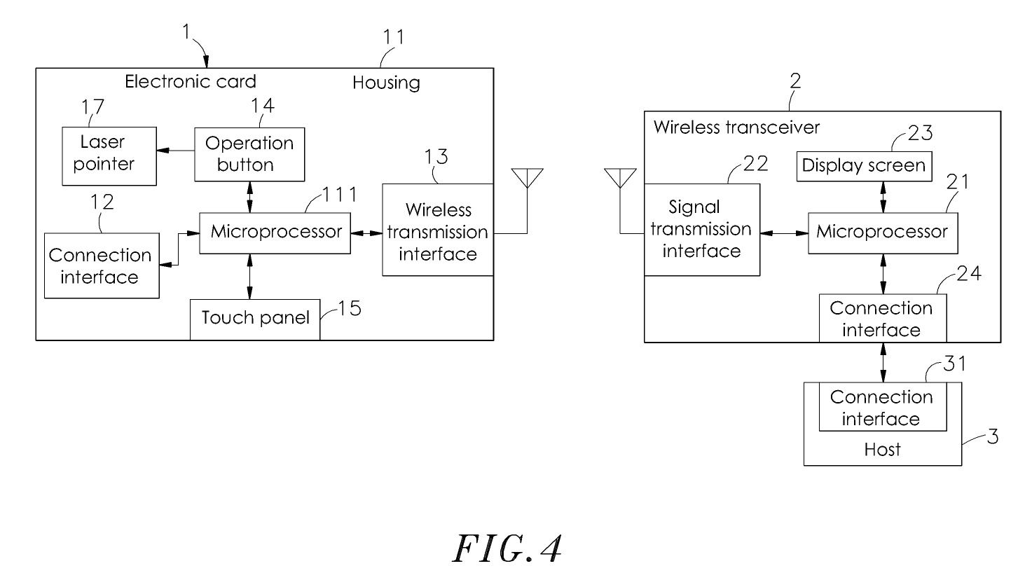

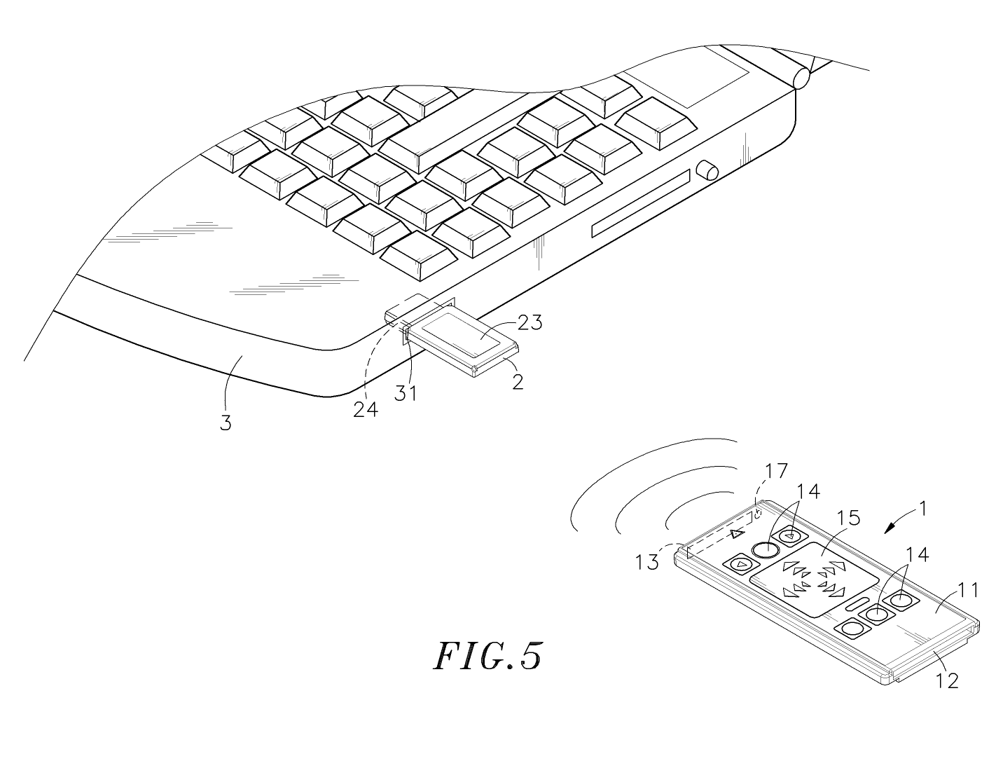

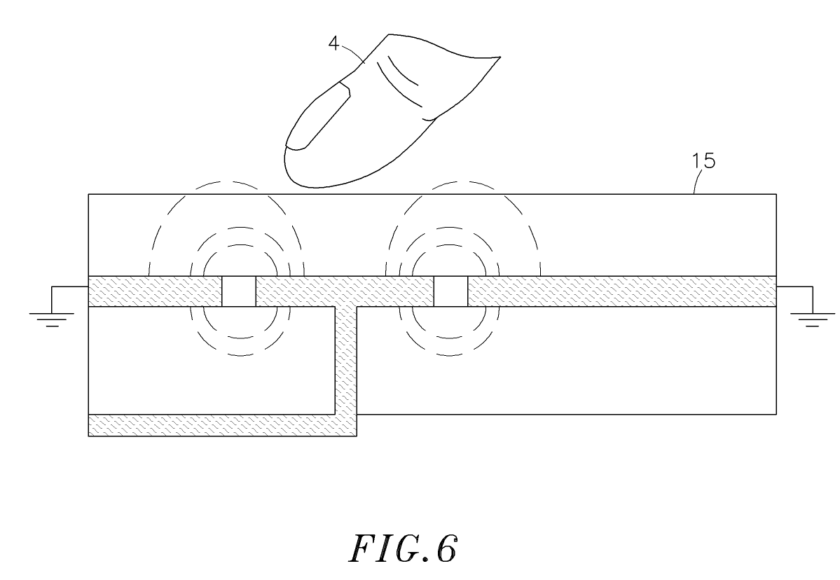

Referring to FIGS. 5 and 6 and FIGS. 3 and 4 again, when using the combination electronic card and wireless transceiver, remove the wireless transceiver 2 from the recessed chamber 16 of the electronic card 1, and then connect the connection interface 24 of the wireless transceiver 2 to the matching connection interface 31 of the host 3 (personal computer, notebook computer, PDA or the like) for two-way wired signal transmission between the wireless transceiver 2 and the host 3 and two-way wireless signal transmission between the wireless transceiver 2 and the electronic card 1. During operation, the display screen 23 of the wireless transceiver 2 displays the related message, so that the user can know whether the signal transmission operation is normal or abnormal.

Further, the user can operate the operation buttons 14 on the top side of the housing 11. When one operation button 14 is clicked, a corresponding signal is provided to the microprocessor 111 for processing, enabling the processed signal to be sent through the wireless transmission interface 13 to the signal transmission interface 22 of the wireless transceiver 2. Upon receipt of the signal from the transmission interface 13, the signal transmission interface 22 sends the signal to the microprocessor 21 for processing, enabling the processed signal to be further sent by the microprocessor 21 to the host 3 via the connection interface 24 of the wireless transceiver 2 and the matching connection interface 31 of the host 3. By means of operating the operation buttons 14, the user can close/open a page on the display screen of the host 3, page up, page down, scroll the displayed page, etc., controlling the host 3 to run a presentation mode. The user can also operate the laser pointer 17 to emit a laser beam for indication.

Further, the touch panel 15 of the electronic card 1 can be a capacitive touch control panel, magnetic induction type touch panel. According to the present preferred embodiment, the touch panel 15 is a capacitive touch control panel comprised of a capacitive touch sensing circuit board that calculates the location of the X, Y coordinates on the touch panel 15 where a finger 4 touches and the direction and speed of the movement of the finger 4 on the touch panel 15. The signal of the coordinates data and moving speed and direction is transmitted through the wireless transmission interface 13 and the signal transmission interface 22 to the wireless transceiver 2 and then sent through the connection interface 24 and the matching connection interface 31 to the host 3 to control the cursor on the display screen of the host 3.

The tissue of the human body is filled with conductive electrolytes covered by a layer of skin and is a lossy dielectric. It is the conductive property of fingers that makes capacitive touch sensing possible. Approaching a finger to fringing electric fields adds conductive surface area to the capacitive system. The additional charge storage capacity added by the finger is known as finger capacitance. When touching the touch panel 15 with a finger 4 and moving the finger 4 on the touch panel 15, a capacitance difference is measured, producing signal indicative of the direction and amount of movement of the finger 4 on the touch panel 15.

As indicated above, the housing 11 of the electronic card 1 has a recessed chamber 16 for accommodating the wireless transceiver 2. When in use, the wireless transceiver 2 is removed from the electronic card 1 and electrically connected to a host 3. At this time, the user can operate the touch panel 15 of the electronic card 1 to control the cursor on the display screen of the host 3 in a wireless manner. Further, the connection interface 12 of the electronic card 1 can be designed for connection to the host 3 capable of reading storage data in the electronic card 1.

In conclusion, the invention provides a combination electronic card and wireless transceiver that has the following advantages and features:

1. The wireless transceiver 2 can be connected with its connection interface 22 to a matching connection interface 31 of a host 3 so that a user can operate the touch panel 15 at the housing 11 of the electronic card 1 with a finger 4 to control the cursor on the display screen of the host 3 wirelessly via the wireless transmission interface 13 and the signal transmission interface 22.

2. The electronic card 1 provides a set of operation buttons 14 through which a user can switch a page on the display screen of the host 3 wirelessly via the wireless transceiver 2.

As stated above, the invention has a touch panel provided at the housing of the electronic card so that a user can operate the touch panel of the electronic card to control the cursor in a wireless manner on the display screen of a host to which the wireless transceiver is connected.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A combination electronic card and wireless transceiver, comprising:
an electronic card, said electronic card comprises a housing, a connection interface provided at one end of said housing, a wireless transmission interface provided at an opposite end of said housing, a microprocessor mounted inside said housing and electrically connected with said connection interface and said wireless transmission interface, a set of operation buttons located on a top side of said housing and electrically connected to said microprocessor of said electronic card for switching of functional selections, a touch panel located on said top side of said housing and electrically connected to said microprocessor of said electronic card for controlling a cursor on a display screen of an external electronic apparatus wirelessly through said wireless transmission interface; and
a wireless transceiver for communication with said electronic card wirelessly.

2. The combination electronic card and wireless transceiver as claimed in claim 1, wherein said connection interface of said electronic card is a card connector.

3. The combination electronic card and wireless transceiver as claimed in claim 1, wherein said wireless transmission interface of said electronic card and said signal transmission interface of said wireless transceiver are an infrared transmission interface.

4. The combination electronic card and wireless transceiver as claimed in claim 1, wherein said wireless transmission interface of said electronic card and said signal transmission interface of said wireless transceiver are a radio transmission interface.

5. The combination electronic card and wireless transceiver as claimed in claim 1, wherein said touch panel is a capacitive touch control panel.

6. The combination electronic card and wireless transceiver as claimed in claim 1, wherein said touch panel is a magnetic induction type touch control panel.

7. The combination electronic card and wireless transceiver as claimed in claim 1, wherein said wireless transceiver can be built-in said external electronic apparatus.

8. The combination electronic card and wireless transceiver as claimed in claim 1, wherein said housing of said electronic card comprises a recessed chamber located on a bottom side for receiving said wireless transceiver; said wireless transceiver comprises a microprocessor, a signal transmission interface electrically connected to said microprocessor for two-way communication with said wireless interface of said electronic card wirelessly, a display screen electrically connected to said microprocessor of said wireless transceiver for indication of signal operation status of said microprocessor of said wireless transceiver, a connection interface electrically connected to said microprocessor of said wireless transceiver for connection to a matching connection interface of an external electronic apparatus for allowing two-way communication between said electronic card and the connected external electronic apparatus wirelessly, and a laser pointer disposed adjacent to one side of said wireless transmission interface.

9. The combination electronic card and wireless transceiver as claimed in claim 1, wherein said wireless transceiver is a wireless transmitter and receiver capable of transmitting and receiving an infrared signal and radio signal.

10. The combination electronic card and wireless transceiver as claimed in claim 1, wherein said connection interface of said wireless transceiver is a USB interface.

11. The combination electronic card and wireless transceiver as claimed in claim 1, wherein said connection interface of said wireless transceiver is an IEEE 1394 interface.

12. The combination electronic card and wireless transceiver as claimed in claim 1, wherein said connection interface of said wireless transceiver is a RS485 interface.
